(19) United States
(12) Patent Application Publication
(10) Pub. No.: US 2026/0142479 A1
(43) Pub. Date: May 21, 2026

(54) CAPACITIVE BATTERY ACTIVE EQUALIZATION CIRCUIT, METHOD, DEVICE AND COMPUTER APPARATUS THEREOF

(71) Applicants: Shenzhen Xinfeihong Electronics Co., Ltd., Shenzhen (CN); Shenzhen Polytechnic University, Shenzhen (CN); Shenzhen Diansi Semiconductor Co., Ltd., Shenzhen (CN)

(72) Inventors: Ming DAI, Shenzhen (CN); Shiyuan CHEN, Shenzhen (CN); Xiaoguang PEI, Shenzhen (CN); Chuang LIN, Shenzhen (CN); Dongyang ZHANG, Shenzhen (CN); Wang KANG, Shenzhen (CN)

(21) Appl. No.: 19/446,910

(22) Filed: Jan. 12, 2026

(30) Foreign Application Priority Data
Aug. 22, 2025 (CN) 202511182943.5

(51) Int. Cl. H02J 7/56; H01M 10/42; H01M 10/44; H01M 10/48; H01M 16/00; H02J 7/34; H02J 7/50; H02J 7/80; H02J 7/96

(52) U.S. Cl. CPC H02J 7/56; H01M 10/4264; H01M 10/441; H01M 10/482; H01M 16/003; H02J 7/345; H02J 7/575; H02J 7/80; H02J 7/96; H01M 2010/4271

(57) ABSTRACT

The invention relates to a capacitive battery active equalization circuit, including a battery pack, an equalizer set, an energy storage capacitor group, and a main control unit, the equalizer set comprises n equalizers; the adjacent equalizers are connected to each other through control signal interaction pins; the main control unit is connected with the control signal interactive pin of the first equalizer or the last equalizer in the equalizer set; the battery pack comprises n+1 batteries connected in series; the energy storage capacitor group includes n capacitors, and each capacitor is connected to the capacitor connection pin of the corresponding equalizer. The switching control module of the equalization chip is used to control the capacitor connection pin to selectively connect with high-voltage battery and low-voltage batteries so as to transfer power and effectively improve equalization efficiency.

### TECHNICAL FIELD

The present disclosure relates to the field of new energy technology, in particular to a capacitive battery active equalization circuit, a method, a device and a computer apparatus thereof.

### BACKGROUND

In the advancement of new energy technologies, the voltage balancing performance of a battery pack plays a decisive role in the overall energy efficiency, safety, and reliability. Due to manufacturing process variations and material inconsistencies among individual cells, as well as non-uniform temperature distribution and fluctuations in charge-discharge rates during cycling, series-connected battery packs are susceptible to cell-to-cell voltage imbalance. This imbalance can lead to a reduction in the actual usable capacity of the battery pack and a shortened cycle life. In severe cases, it may even induce local overcharging or over-discharging, thereby introducing safety risks.

Current mainstream battery equalization technologies can be categorized into two types: passive (dissipative) balancing and active (non-dissipative) balancing. Passive balancing technology achieves voltage equalization by connecting discharge resistors in parallel with higher-voltage cells in an energy-dissipating manner. However, it suffers from drawbacks such as low energy utilization efficiency, slow equalization speed, and significant heat generation, making it difficult to meet the application requirements of large-capacity battery packs. Active balancing technology employs energy storage components such as capacitors, inductors, or transformers to transfer energy between cells. Compared with passive balancing, it significantly improves energy utilization and equalization efficiency, and has thus become the mainstream focus of current research and application. Nevertheless, the topological structures of existing active balancing circuits are often complex, leading to cumbersome system design and high costs. Moreover, these methods typically rely on voltage differences between adjacent cells to enable localized energy transfer. In multi-cell series-connected battery packs, it is challenging to reconcile local equalization with global consistency, resulting in low overall balancing efficiency.

In light of the aforementioned issues, there is an urgent need to develop a novel capacitive active balancing technology tailored for series-connected battery packs.

### SUMMARY

Based on this, it is necessary to propose a capacitive battery active equalization circuit, a method, a device and a computer apparatus for the problem of low equalization efficiency of the existing active equalization technology.

The first aspect of the present disclosure provides a capacitive battery active equalization circuit, including a battery pack, an equalizer set, an energy storage capacitor group, and a main control unit;
the equalizer set includes n equalizers, each equalizer includes a battery connection pin, a capacitor connection pin, a switching control module and a control signal interaction pin; the adjacent equalizers are connected to each other through the control signal interaction pins; the main control unit is connected with the control signal interactive pin of a first equalizer or a last equalizer in the equalizer set;
the battery pack includes n+1 batteries connected in series; the battery connection pins of the i-th equalizer are connected to an i-th battery and an i+1-th battery respectively; where i is a natural number, and 1≤i≤n;
the energy storage capacitor group includes n capacitors, each capacitor is connected to the capacitor connection pin of a corresponding equalizer;
the switching control module of the equalizer is configured to control the capacitor connection pin to selectively connect with a high-voltage battery or a low-voltage battery according to a voltage difference between adjacent batteries detected by the battery connection pin and a global control command sent by the main control unit for power transfer.

The second aspect of the present disclosure provides a capacitive battery active equalization method, which is applied to the above-mentioned capacitive battery active equalization circuit, the capacitive battery active equalization method includes:
monitoring a voltage of each battery in the battery pack continuously by the battery connection pins of each equalizer, and sending a voltage to the main control unit;
calculating a current maximum voltage difference in the battery pack simultaneously by the main control unit, the current maximum voltage difference is a voltage difference between a battery with a highest voltage and a battery with a lowest voltage in the battery pack;
judging whether the current maximum pressure difference is greater than the preset maximum pressure difference threshold;
if the current maximum pressure difference is not greater than a preset maximum pressure difference threshold, then the i-th equalizer judges whether an adjacent voltage difference between the i-th battery and the i+1-th battery connected to the i-th equalizer is greater than a first adjacent voltage difference threshold, 1≤i≤n;
if the adjacent voltage difference of the i-th equalizer is greater than the first adjacent voltage difference threshold, connecting the capacitor connected to the i-th equalizer to the i-th battery and the i+1-th battery via the switching control module of the i-th equalizer, after charging the battery with a higher voltage, switching to the battery with a lower voltage for discharging, and performing a charging and discharging operation of the capacitor continuously at a first preset frequency until an adjacent voltage difference between adjacent batteries is less than or equal to a second adjacent voltage difference threshold.

In some embodiments, after judging whether the current maximum pressure difference is greater than the preset maximum pressure difference threshold, the steps also include:
if the current maximum pressure difference is greater than the preset maximum pressure difference threshold, identifying all batteries with voltage outliers from the battery pack, and selecting a target battery from the batteries with the voltage outliers, and recording a sequence number j of the target battery;
judging whether a voltage of the target battery is less than an average voltage of the battery pack;
if the voltage of the target battery is less than the average voltage of the battery pack, for the i-th equalizer, judging whether i is less than j;
if i<j, then judging whether a voltage of the i+1-th battery is less than the voltage of the i-th battery, respectively; if the voltage of the i+1-th battery is less than the voltage of the i-th battery, the capacitor connected to the i-th equalizer is connected to the i-th battery for charging via the switching control module of the i-th equalizer, and then switching to the i+1-th battery for discharging, and performing the charging and discharging operation of the capacitor continuously at a second preset frequency until a preset stop equalization condition is satisfied; if the voltage of the i+1-th battery is greater than the voltage of the i-th battery, the i-th equalizer does not perform the charging and discharging operation of the capacitor;
if i≥j, then judging whether the voltage of the i+1-th battery is greater than the voltage of the i-th battery, respectively; if the voltage of the i+1-th battery is greater than the voltage of the i-th battery, the capacitor connected to the i-th equalizer is connected to and the i+1-th battery for charging via the switching control module of the i-th equalizer, and then switching to the i-th battery for discharging, and performing the charging and discharging operation of the capacitor continuously at the second preset frequency until the preset stop equalization condition is satisfied; if the voltage of the i+1-th battery is less than the voltage of the i-th battery, the i-th equalizer does not perform the charging and discharging operation of the capacitor.

In some embodiments, after judging whether the current maximum pressure difference is greater than the preset maximum pressure difference threshold, the steps also include:
if the voltage of the target battery is greater than the average voltage of the battery pack, for the i-th equalizer, judging whether i is less than j;
if i≥j, then judging whether the voltage of the i+1-th battery is less than the voltage of the i-th battery, respectively; if the voltage of the i+1-th battery is less than the voltage of the i-th battery, the capacitor connected to the i-th equalizer is connected to and the i-th battery for charging via the switching control module of the i-th equalizer, and then switching to the i+1-th battery for discharging, and performing the charging and discharging operation of the capacitor continuously at the second preset frequency until the preset stop equalization condition is satisfied; if the voltage of the i+1-th battery is less than the voltage of the i-th battery, the i-th equalizer does not perform the charging and discharging operation of the capacitor;
if i<j, then judging whether the voltage of the i+1-th battery is greater than the voltage of the i-th battery, respectively; if the voltage of the i+1-th battery is greater than the voltage of the i-th battery, the capacitor connected to the i-th equalizer is connected to the i-th battery for charging via the switching control module of the i-th equalizer, and then switching to the i-th battery for discharging, and performing the charging and discharging operation of the capacitor continuously at a second preset frequency until a preset stop equalization condition is satisfied; if the voltage of the i+1-th battery is less than the voltage of the i-th battery, the i-th equalizer does not perform the charging and discharging operation of the capacitor
In some embodiments, identifying all batteries with voltage outliers from the battery pack, and selecting a target battery from the batteries with the voltage outliers, the steps include:
calculating the average voltage of the battery pack;
calculating a deviation difference between the voltage of each battery and the average voltage, respectively;
the battery whose deviation difference exceeds a preset deviation threshold is used as the battery with voltage outliers, and adding all batteries with voltage outliers to an outlier battery set;
judging a current state of the battery pack, and the current state is selected from a charging state, a discharging state and a standing state;
according to a preset correspondence between a state-voltage deviation direction, selecting a voltage deviation direction corresponding to the current state of the battery pack from the outlier battery set, and selecting the battery with a largest deviation difference as the target battery.

In some embodiments, according to the preset correspondence between the state-voltage deviation direction, selecting a voltage deviation direction corresponding to the current state of the battery pack from the outlier battery set, and selecting the battery with a largest deviation difference as the target battery, the steps include:
if the current state of the battery pack is a charging state, the voltage deviation direction corresponding to the charging state in the preset correspondence is a positive deviation direction, and selecting the battery with a voltage higher than the average voltage and the maximum deviation difference from the outlier battery set as the target battery;
if the current state of the battery pack is a discharging state, the voltage deviation direction corresponding to the discharging state in the preset correspondence is a negative deviation direction, and selecting the battery with the voltage lower than the average voltage and the maximum deviation difference from the outlier battery set as the target battery;
if the current state of the battery pack is a standing state, selecting the battery with the largest deviation difference from the outlier battery set as the target battery;
if there is no battery with the voltage deviation direction corresponding to the current state in the outlier battery set, selecting the battery with the largest deviation difference from the outlier battery set as the target battery.

In some embodiments, the preset stop equalization condition includes at least one of the following:
a real-time voltage difference between an average voltage of the target battery and the battery pack is less than the preset deviation threshold;
the maximum pressure difference of the battery pack is less than or equal to the preset maximum pressure difference threshold;
a duration of the charging and discharging operation of the capacitor exceeds a preset equalization time.

In some embodiments, configuration steps of the second preset frequency include:
calculating a distance level d=|i−j| between the i-th equalizer and the target battery j, respectively;
configuring a second preset frequency of the i-th equalizer according to the distance level, where the second preset frequency is configured to decrease as the distance level increases.

The third aspect of the present disclosure provides a capacitive battery active equalization device, which is applied to the above-mentioned capacitive battery active equalization circuit, the capacitive battery active equalization device includes:
a voltage detection module, configured to continuously monitor the voltage of each battery in the battery pack through the battery connection pin of each equalizer, and send the voltage to the main control unit;
a main control calculation module, configured to calculate the current maximum pressure difference in the battery pack simultaneously by the main control unit, the current maximum pressure difference is the voltage difference between the battery with the highest voltage and the battery with the lowest voltage in the battery pack;
a pressure difference judgment module, configured to judge whether the current maximum pressure difference is greater than the preset maximum pressure difference threshold;
an equalization comparison module, configured to judge if the current maximum pressure difference is not greater than the preset maximum pressure difference threshold, then the i-th equalizer judges whether the adjacent voltage difference between the i-th battery and the i+1-th battery connected to the i-th equalizer is greater than the first adjacent voltage difference threshold, 1≤i≤n;
a first equalization module, configured to connect the capacitor connected to the i-th equalizer to the i-th battery and the i+1-th battery through the switching control module of the i-th equalizer if the adjacent voltage difference of the i-th equalizer is greater than the first adjacent voltage difference threshold, after charging, a battery with a lower voltage is switched for discharging, and the charging and discharging operation of the capacitor is continuously performed at the first preset frequency until the adjacent voltage difference between adjacent batteries is less than or equal to the second adjacent voltage difference threshold.

The fourth aspect of the present disclosure provides a computer apparatus, including a memory and a processor, the memory stores a computer program, and when the computer program is executed by the processor, the processor performs the steps of the capacitive battery active equalization method.

The capacitive active battery equalization circuit of the present disclosure reduces circuit complexity and hardware cost through the series connection of adjacent equalizers and the interconnection between the main control unit and the first and last chips in the chain. Each equalizer is capable of independently monitoring the voltage of adjacent battery cells and performing equalization operations. By connecting adjacent equalizers to the same battery cell, continuous energy transfer among multiple cells can be achieved, enabling coordinated equalization across different chips. Simultaneously, in combination with the global regulation executed by the main control unit, coordination between local and global equalization is realized, which effectively shortens the equalization time and enhances equalization efficiency. Furthermore, the number of equalizers can be flexibly adjusted according to the count of series-connected battery cells, meeting the requirements of battery packs of varying scales, thereby exhibiting broad application prospects in the field of new energy. Utilizing capacitors as energy storage elements for energy transfer, compared with passive equalization techniques, this approach reduces energy loss, improves the energy utilization rate of the battery pack, and extends battery cycle life and service life.

The capacitive active battery equalization method of the present disclosure, based on the judgment of the current maximum voltage difference and a preset maximum voltage difference threshold, initiates only local equalization when the overall voltage consistency of the battery pack is favorable. Under such conditions, each equalizer operates independently to ensure that the voltage across each section of the battery pack remains within a reasonable range, thereby avoiding unnecessary global equalization coordination and improving overall equalization efficiency. Meanwhile, when the overall voltage consistency of the battery pack is maintained at a high level, the main control unit primarily assumes responsibility for global state monitoring, while specific equalization operations are carried out independently by each equalizer. This distribution of tasks reduces the computational load on the main control unit, resulting in a more responsive and stable performance of the entire equalization system.

### BRIEF DESCRIPTION OF THE DRAWINGS

To more clearly illustrate the technical solutions in the embodiments of the present disclosure or the prior art, the accompanying drawings required for use in the description of the embodiments or the prior art are briefly introduced below. The drawings in the following description are merely some embodiments of the present present disclosure. Based on these drawings, a person of ordinary skill in the art may also obtain other drawings without involving any creative effort.

Among them:

FIG. 1 is a schematic diagram of the capacitive battery active equalization circuit in an embodiment.

FIG. 2 is a flow chart of the capacitor battery active equalization method in an embodiment.

FIG. 3 is a structural block diagram of the capacitive battery active equalization device in an embodiment.

FIG. 4 is a structural diagram of the computer apparatus in an example.

### DETAILED DESCRIPTION OF THE EMBODIMENTS

The following will be combined with the drawings of the embodiment of the present disclosure to clearly and completely describe the technical scheme of the embodiment of the present disclosure. Obviously, the described embodiment is only part of the embodiment of the present disclosure, not all of the embodiment. Based on the embodiments in this present disclosure, all other embodiments obtained by ordinary technicians in this field without making creative labor belong to the protection scope of this present disclosure.

The embodiment of the present disclosure provides a capacitive battery active equalization circuit, including a battery pack, an equalizer set, an energy storage capacitor set and a main control unit.

The equalizer set includes n equalizers, each equalizer includes a battery connection pin, a capacitor connection pin, a switching control module and a control signal interaction pin, the adjacent equalizers are connected to each other through the control signal interaction pins; the main control unit is connected with the control signal interactive pin of the first equalizer or the last equalizer in the equalizer set.

The battery pack includes n+1 batteries connected in series; the battery connection pins of the i-th equalizer are connected to the i-th battery and the i+1-th battery respectively; where i is a natural number, and 1≤i≤n;
the energy storage capacitor group includes n capacitors, each capacitor is connected to the capacitor connection pin of the corresponding equalizer;
the switching control module of the equalizer is configured to control the capacitor connection pin to selectively connect with a high-voltage battery or a low-voltage battery according to a voltage difference between adjacent batteries detected by the battery connection pin and a global control command sent by the main control unit for power transfer.

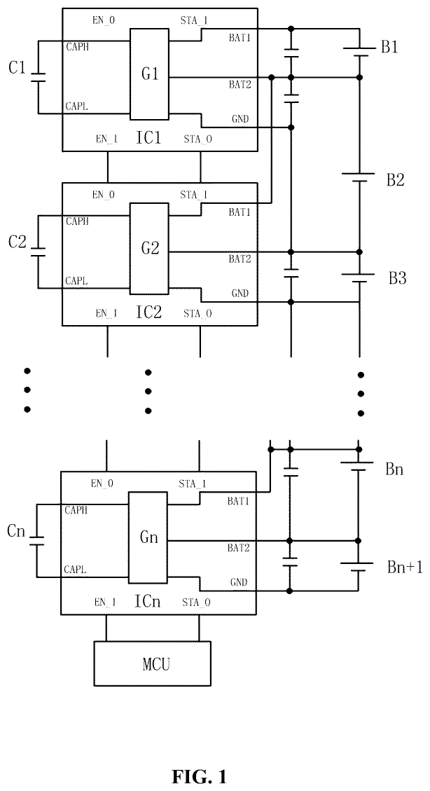

FIG. 1 is a schematic diagram of the capacitive battery active equalization circuit in a specific embodiment, including: a battery pack, an equalizer set, an energy storage capacitor group and a main control unit MCU.

The equalizer set contains n equalizers, which are denoted as chip IC1, chip IC2 . . . Chip ICn. Each equalizer integrates battery connection pin, capacitor connection pin, switching control module and control signal interaction pin. n≥1. In some preferred embodiments, n≥2; in some further preferred embodiments, 3≤n≤20. The battery pack contains n+1 single cells connected in series, which are recorded as battery B1, battery B2, battery B3 . . . battery Bn, battery Bn+1. The energy storage capacitor group contains n capacitors, which are recorded as capacitor C1, capacitor C2 . . . capacitor Cn. The two ends of each capacitor Ci are connected to the capacitor connection pin of the chip ICi respectively.

The battery connection pin of the chip ICi (1≤i≤n) is connected to the battery Bi and the battery Bi+1 respectively; the adjacent chips are connected to the same battery, the capacitor connection pin of the chip ICi is connected to the capacitor Ci, the switching control module Gi is set in the chip ICi, the control signal interaction pins between the adjacent chip ICi and ICi+1 are connected to each other. Specifically, with reference to FIG. 1, the BAT1 pin of the chip IC1 is connected to the B1 positive electrode of the battery, the BAT2 pin of the chip IC1 is connected to the B2 positive electrode of the battery, and the BI and B2 negative electrodes are connected to the GND pin of the chip IC1; the energy storage capacitor C1 is connected between the CAPH pin and the CAPL pin of the chip IC1, and the switching control module G1 of the chip IC1 is used to control the connection of the capacitor CI with BI or B2; the BAT1 pin of the chip IC2 is connected to the B2 positive electrode of the battery, the BAT2 pin of the chip IC2 is connected to the B3 positive electrode of the battery, and the negative electrodes of B2 and B3 are connected to the GND pin of the chip IC2. The energy storage capacitor C2 is connected between the CAPH pin and the CAPL pin of the chip IC2, and the switching control module G2 of the chip IC2 is used to control the connection between the capacitor C2 and B2 or B3; the EN_I of the enabling input leg of the chip IC1 is connected with the EN_O of the enabling output leg of the chip IC2, and the STA_O of the equalization state output of the chip IC1 is connected with the STA_I of the equalization state input leg of the chip IC2; chip IC1 and chip IC2 are connected to the same battery B2. In FIG. 1, each battery is also connected in parallel with a capacitor for voltage stabilization, which is smaller than the capacitor capacity of the energy storage capacitor group. Multiple chips are connected in the same series connection mode until connected to the chip ICn, forming a series signal transmission link. The enable input pin EN_I and the equalization state output STA_O of ICn are connected to the main control unit MCU. Therefore, the global control instructions of the main control unit MCU can be transmitted to all chips in turn through the chip ICn, and the equalization state of each chip can also be fed back to the main control unit MCU through each chip. The equalization state of the chip includes at least the voltage, current and other parameters of the two batteries connected to the chip. In some optional embodiments, in combination with other sensors, parameters such as temperature, capacity, and state of charge can also be included, since it is not the focus of the present disclosure, the present disclosure does not elaborate on it.

The main control unit MCU stores necessary data such as preset voltage thresholds, correlation correspondences, and equalization start-stop conditions. It is responsible for receiving equalization states such as battery voltage data fed back by each chip, calculating the overall voltage of the battery pack, and generating corresponding global control instructions. The global control instructions include equalization start/stop signals, equalization frequency parameters, equalization direction control, etc., which are sent to the equalizer set to control the equalization operation of each chip to achieve the overall management of the entire equalization process.

When the battery pack starts to work, each chip ICi collects the voltage of the battery Bi and the battery Bi+1 in real time through the battery connection pin, and transmits the collected voltage data to the chip ICn in turn through the control signal interaction pin, and then fed back by the chip ICn to the main control unit MCU. The main control unit MCU analyzes the received voltage data. If it is judged that the equalization operation is needed, the global control command is generated and sent to the chip ICn, and the chip ICn passes the command to each chip ICi. The ICi of each chip controls the connection state of the capacitor Ci by switching the control module Gi according to the voltage difference of the adjacent battery and the global control instruction. When the voltage of the battery Bi is higher than that of the battery Bi+1, the switching control module first connects the capacitor Ci to the battery Bi for capacitor charging. After the charging is completed, the switch is connected to the battery Bi+1 for capacitor discharge, thereby transferring the energy of the battery Bi to the battery Bi+1; on the contrary, energy transfer in the opposite direction is performed until the voltage difference between adjacent batteries reaches the preset equalization target. The switching control module Gi can realize the connection switching through the mature MOS switch circuit. During the whole equalization process, the working state of each chip ICi will be fed back to the main control unit MCU in real time. The main control unit MCU dynamically adjusts the global control instructions according to the feedback information to ensure that the equalization process is efficient and stable.

The embodiment reduces the circuit complexity and hardware cost through the series connection of adjacent equalizers and the connection between the main control unit and the first/last chip. Each equalizer can independently monitor the voltage of adjacent batteries and perform equalization operations. The adjacent equalizers are connected to the same battery so that the continuous transfer of energy between multiple batteries can be realized, and the coordinated equalization across chips can be realized. Meanwhile, combined with the global regulation of the main control unit, the coordination of local equalization and global equalization is realized, which effectively shortens the equalization time and improves the equalization efficiency. Meanwhile, the number of equalizers can be flexibly adjusted according to the number of battery packs in series to meet the needs of battery packs of different scales, which has a wide application prospect in the field of new energy. The capacitor is used as an energy storage element for energy transfer. Compared with the passive equalization technology, the energy loss is reduced, the energy utilization rate of the battery pack is improved, and the battery life and service life are prolonged.

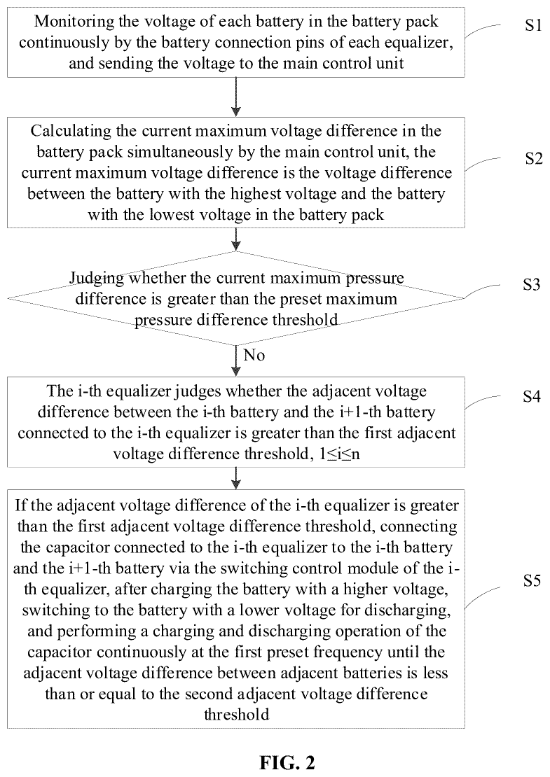

FIG. 2 is a schematic diagram of the capacitive battery active equalization method in an embodiment, which is applied to the aforementioned capacitive battery active equalization circuit. The capacitive battery active equalization method includes:
S1: The voltage of each battery in the battery pack is monitored continuously by the battery connection pins of each equalizer, and the voltage is sent to the main control unit;
S2: The current maximum voltage difference in the battery pack is calculated simultaneously by the main control unit, the current maximum voltage difference is a voltage difference between the battery with the highest voltage and the battery with the lowest voltage in the battery pack;
S3: Whether the current maximum pressure difference is greater than the preset maximum pressure difference threshold is judged;
S4: If the current maximum pressure difference is not greater than the preset maximum pressure difference threshold, then the i-th equalizer judges whether an adjacent voltage difference between the i-th battery and the i+1-th battery connected to the i-th equalizer is greater than the first adjacent voltage difference threshold, 1≤i≤n;
S5: If the adjacent voltage difference of the i-th equalizer is greater than the first adjacent voltage difference threshold, the capacitor connected to the i-th equalizer is connected to the i-th battery and the i+1-th battery via the switching control module of the i-th equalizer, after charging the battery with a higher voltage, it is switched to the battery with a lower voltage for discharging, and the charging and discharging operation of the capacitor is continuously performed at the first preset frequency until an adjacent voltage difference between adjacent batteries is less than or equal to the second adjacent voltage difference threshold.

In this embodiment, in the above S1, each equalizer continuously monitors the voltage of the adjacent two batteries connected by its own battery connection pin. Taking the first equalizer as an example, the voltage of the first battery and the second battery is collected in real time. The second section balance chip collects the voltage of the second section battery and the third section battery in real time, and so on. The collected voltage data is transmitted to the final equalizer step by step through the series link formed by the control signal interaction pins between the equalizers, and then fed back to the main control unit by the final equalizer.

In the above S2, after receiving the voltage data transmitted by each equalizer, the main control unit analyzes all the battery voltages at the same time, compares the battery with the highest voltage and the battery with the lowest voltage, and calculates the difference between the two batteries, the difference is the current maximum pressure difference. For example, if the highest voltage in the battery pack is the third section of the battery (voltage is 3.8 V), and the lowest voltage is the fifth section of the battery (voltage is 3.6 V), the current maximum voltage difference is 0.2 V.

In the above S3, the main control unit compares the calculated current maximum pressure difference with the preset maximum pressure difference threshold. The preset maximum pressure difference threshold can be preset and stored in the memory of the main control unit according to the characteristics of the battery pack and the actual application requirements. For example, it is set to 0.3V, which is used to determine whether the battery pack needs a global range of equalization intervention.

In the above S4, when the judgment result is that the current maximum pressure difference is not greater than the preset maximum pressure difference threshold, there is no need to start the global equalization strategy, and each equalizer independently performs local judgment. Each equalizer calculates the adjacent voltage difference between the two batteries according to the voltage of the adjacent two batteries collected by itself, and compares the difference with the first adjacent voltage difference threshold. The first adjacent voltage difference threshold is usually set to a small value, such as 0.05V, to identify whether there is a voltage deviation between adjacent batteries that needs to be adjusted.

In the above S5, if the equalizer judges that the adjacent voltage difference is greater than the first adjacent voltage difference threshold, the switching control module of the equalizer starts to work and controls the capacitor connected to it to charging and discharging. Specifically, the switching control module first connects the capacitor to the battery with higher voltage in the adjacent two batteries, and uses the high-voltage battery to charge the capacitor; when the capacitor is charged to a stable state, the switching control module switches the capacitor to a battery with a lower voltage, so that the capacitor discharges to the low voltage battery, thereby realizing the transfer of energy from the high voltage battery to the low voltage battery. The charging and discharging process continues at the first preset frequency. The first preset frequency can be determined according to the characteristics of the capacitor and the equalization speed requirement. The first preset frequency can be a preset value. In the equalization process, the equalizer continuously monitors the voltage difference between adjacent batteries. When the adjacent voltage difference is less than or equal to the second adjacent voltage difference threshold (such as 0.025 V), the charging and discharging operation is stopped to complete the local equalization.

In this embodiment, in the capacitive active battery equalization method of the present disclosure, by comparing the current maximum voltage difference with a preset threshold, local equalization is selectively activated when the overall voltage consistency of the battery pack is satisfactory. Under such conditions, each equalizer operates independently to maintain the voltage of every section within a reasonable range, thereby avoiding unnecessary global coordination and improving overall equalization efficiency. Simultaneously, when the battery pack exhibits good overall voltage consistency, the main control unit primarily assumes responsibility for global state monitoring, while specific equalization tasks are carried out independently by each equalizer. This distribution of workload reduces the operational burden on the main control unit, resulting in a more responsive and stable performance of the entire equalization system.

In a specific embodiment, after S3 of judging whether the current maximum pressure difference is greater than the preset maximum pressure difference threshold, it also includes:
S6: If the current maximum pressure difference is greater than the preset maximum pressure difference threshold, all batteries with voltage outliers are identified from the battery pack, and a target battery is selected from the batteries with the voltage outliers, and the sequence number j of the target battery is recorded;
S7: Whether the voltage of the target battery is less than the average voltage of the battery pack is judged;
S8: If the voltage of the target battery is less than the average voltage of the battery pack, then for the i-th equalizer, judge whether i is less than j;
S9: If i<j, whether the voltage of the i+1-th battery is less than the voltage of the i-th battery is judged; if the voltage of the i+1-th battery is less than the voltage of the i-th battery, the capacitor connected to the i-th equalizer is connected to the i-th battery for charging via the switching control module of the i-th equalizer, and then switched to the i+1-th battery for discharging, and the charging and discharging operation of the capacitor is continuously performed at the second preset frequency until the preset stop equalization condition is satisfied. If the voltage of the i+1-th battery is greater than the voltage of the i-th battery, the i-th equalizer does not perform the charging and discharging operation of the capacitor;
S10: If i≥j, whether the voltage of the i+1-th battery is greater than the voltage of the i-th battery is judged; if the voltage of the i+1-th battery is greater than the voltage of the i-th battery, the capacitor connected to the i-th equalizer is connected to the i+1-th battery through the switching control module of the i-th equalizer. After charging, it is switched to the i-th battery for discharging, and the charging and discharging operation of the capacitor is continuously performed at the second preset frequency until the preset stop equalization condition is satisfied. If the voltage of the i+1-th battery is less than the voltage of the i-th battery, the i-th equalizer does not perform the charging and discharging operation of the capacitor.

In this embodiment, based on the embodiment of the above-mentioned capacitive battery active equalization method, when the current maximum pressure difference and the preset maximum pressure difference threshold are judged, if the current maximum pressure difference is greater than the preset maximum pressure difference threshold, the overall voltage consistency of the battery pack is poor, and there is a more obvious voltage deviation from the battery.

In the above S6, the main control unit identifies all batteries with outliers in voltages from the battery pack, selects a target battery from them, and records the serial number of the target battery to locate the battery that needs to be balanced first.

In the above S7, whether the voltage of the target battery is less than the average voltage of the battery pack is judged, which is used to determine whether the target battery is a battery with too low voltage or a battery with too high voltage, and is used to determine the equalization operation direction of energy transfer in the subsequent steps.

In the above S8, when the voltage of the target battery is less than the average voltage of the battery pack, it is necessary to charge the target battery to increase the voltage, that is, the energy is balanced in a direction centered on the target battery. For each equalizer, it is necessary to first determine the size relationship between the serial number and the target battery serial number to determine the transmission direction of the equalization energy.

In the above S9, if the sequence number of the equalizer is less than the sequence number of the target battery, it is judged whether the voltage of the i+1-th battery is less than the voltage of the i-th battery. If the voltage of the i+1-th battery is less than the voltage of the i-th battery, the energy can be transferred from the i-th battery to the i+1-th battery, and then gradually converge to the target battery, the main control unit judges the balance of the corresponding equalizer. At this time, the switching control module of the equalizer will first charge the connected capacitor with the i-th battery connection. After the charging is completed, it will be switched to the i+1-th battery connection for discharging, and the capacitor charging and discharging operation will be continuously performed at the second preset frequency until the preset stop equalization condition is satisfied. The second preset frequency can be a preset value or a value that changes according to specific conditions, if the i+1-th battery voltage is greater than the i-th battery voltage, it indicates that the energy transfer direction between the two batteries does not meet the need to replenish energy to the target battery, the equalizer does not perform the charging and discharging operation of the capacitor to avoid the reverse flow of energy.

In the above S10, if the sequence number of the equalizer is greater than or equal to the sequence number of the target battery, whether the voltage of the i+1-th battery is greater than the voltage of the i-th battery is judged. When the voltage of the i+1-th battery is greater than the voltage of the i-th battery, the energy can be transferred from the i+1-th battery to the i-th battery, so as to supplement the energy to the target battery, and the main control unit judges the balance of the corresponding equalizer. At this time, the switching control module of the equalizer will charge the capacitor connected to it first with the i+1-th battery, and then switch to discharge with the i-th battery, and continue to charging and discharging at the second preset frequency until the stop condition is met. If the i+1-th battery voltage is less than the i-th battery voltage, the equalizer does not perform charging and discharging operations to avoid reverse energy flow.

In this embodiment, when the overall voltage consistency in the battery pack is poor and there is a battery with a large voltage deviation, the global priority equalization is performed. The main control unit selectively starts the equalization operation of the equalizer according to the position relationship between the equalizer and the target battery and the voltage of the connected battery, so as to efficiently replenish energy to the low-voltage target battery and quickly improve the overall voltage consistency of the battery pack. Meanwhile, each equalizer selectively performs charging and discharging operations according to the actual situation, avoiding invalid energy transfer back and forth, reducing energy loss and improving equalization efficiency.

In a specific embodiment, the S8 determines whether the voltage of the target battery is less than the average voltage of the battery pack also includes:
S11: If the voltage of the target battery is greater than the average voltage of the battery pack, for the i-th equalizer, determine whether i is less than j;
S12: If i≥j, whether the voltage of the i+1-th battery is less than the voltage of the i-th battery is judged; if the voltage of the i+1-th battery is less than the voltage of the i-th battery, through the switching control module of the i-th equalizer, the capacitor connected to the i-th equalizer is connected to the i-th battery for charging, and then switched to the i+1-th battery for discharging, and the charging and discharging operation of the capacitor is continuously performed at the second preset frequency until the preset stop equalization condition is satisfied. If the voltage of the i+1-th battery is greater than the voltage of the i-th battery, the i-th equalizer does not perform the charging and discharging operation of the capacitor;
S13: If i<j, whether the voltage of the i+1-th battery is greater than the voltage of the i-th battery is judged; if the voltage of the i+1-th battery is greater than the voltage of the i-th battery, through the switching control module of the i-th equalizer, the capacitor connected to the i-th equalizer is connected to the i+1-th battery for charging, and then switched to the i-th battery for discharging, and the charging and discharging operation of the capacitor is continuously performed at the second preset frequency until the preset stop equalization condition is satisfied; if the voltage of the i+1-th battery is less than the voltage of the i-th battery, the i-th equalizer does not perform the charging and discharging operation of the capacitor.

In this embodiment, in the above S11, after judging the current maximum pressure difference and the preset maximum pressure difference threshold, if the current maximum pressure difference is greater than the preset maximum pressure difference threshold, it shows that the overall voltage consistency of the battery pack is poor, and there is a more obvious voltage deviation from the battery, when the main control unit further judges that the voltage of the target battery is greater than the average voltage of the battery pack, it means that the target battery needs to release energy outward to achieve voltage balance of the battery pack. For each equalizer, it is necessary to first determine the size relationship between its serial number and the target battery serial number, and then perform the corresponding charging and discharging operation according to the voltage of the connected battery.

In the above S12, if the sequence number of the equalizer is greater than or equal to the sequence number of the target battery, it is judged whether the voltage of the i+1-th battery is less than the voltage of the i-th battery. When the i+1-th battery voltage is less than the i-th battery voltage, the energy can be transferred from the i-th battery to the i+1-th battery, thereby achieving the outward release of the target battery energy, and the main control unit judges to start the equalization of the corresponding equalizer. At this time, the switching control module of the equalizer will first connect the connected capacitor to the i-th battery for charging, and then switch to the i+1-th battery for discharging after the charging is completed. The charging and discharging operation is continuously performed at the second preset frequency until the preset stopping equalization condition is satisfied. The second preset frequency can be a preset value or a value that changes according to specific conditions, if the i+1-th battery voltage is greater than the i-th battery voltage, the direction of energy transfer between the two batteries is inconsistent with the demand for energy released by the target battery, the equalizer does not perform the charging and discharging operation of the capacitor to avoid reverse energy accumulation.

In the above S12, if the sequence number of the equalizer is less than the sequence number of the target battery, the voltage of the i+1-th battery connected to the i-th battery is determined. When the i+1-th battery voltage is greater than the i-th battery voltage, the energy can be transferred from the i+1-th battery to the i-th battery, and then the energy of the target battery can be released outward. The main control unit judges to start the equalization of the corresponding equalizer. The equalization process is the same as the above steps, and will not be repeated here. If the i+1-th battery voltage is less than the i-th battery voltage, the equalizer does not perform charging and discharging operations to avoid reverse energy accumulation.

In this embodiment, when the overall voltage consistency in the battery pack is poor and there is a battery with a large voltage deviation, the global priority equalization is performed. The main control unit selectively starts the equalization operation of the equalizer according to the position relationship between each equalizer and the target battery and the voltage situation of the adjacent battery, so as to efficiently transfer the excess energy of the target battery to other batteries and quickly improve the overall voltage consistency of the battery pack. Meanwhile, each equalizer selectively performs charging and discharging operations according to the actual situation, avoiding invalid energy transfer back and forth, reducing energy loss and improving equalization efficiency.

In a specific embodiment, the all batteries with voltage outliers are identified from the battery pack, and a target battery is selected from the battery with the voltage outliers in S6, including:
S601: The average voltage of the battery pack is calculated;
S602: The deviation difference between the voltage of each battery and the average voltage is calculated;
S603: The battery whose deviation difference exceeds the preset deviation threshold is used as the battery with voltage outliers, and the battery with voltage outliers is added to the outlier battery set;
S604: The current state of the battery pack is judged, the current state is selected from the charging state, the discharging state and the standing state;
S605: According to the preset correspondence between the state-voltage deviation direction, the voltage deviation direction corresponding to the current state of the battery pack is selected from the outlier battery set, and the battery with the largest deviation difference is selected as the target battery.

In this embodiment, in the above S601, the main control unit obtains the real-time voltage of each battery in the battery pack, adds all the voltages and divides them by the number of batteries, and the result is the average voltage of the battery pack.

In the above S602-S603, for each battery, the absolute value of the difference obtained by subtracting the average voltage from its voltage is the deviation difference of the battery, the preset deviation threshold can be set according to the characteristics of the battery pack and the actual application scenario, such as 0.2V.

In the above S604, it can be judged by the current direction of the battery pack and other information, such as when there is a current flowing into the battery pack, it is judged as the charging state; when there is a current flowing out of the battery pack, it is judged as the discharging state; when there is neither current inflow nor current outflow, it is judged to be in a standing state.

In the above S605, according to the preset correspondence between the state-voltage deviation direction, the target battery is selected from the outlier battery set. Specifically, according to the preset correspondence between the state-voltage deviation direction, the voltage deviation direction corresponding to the current state of the battery pack is selected from the outlier battery set, and the battery with the largest deviation difference is selected as the target battery in S605, including:
S6051: If the current state of the battery pack is a charging state, the voltage deviation direction corresponding to the charging state in the preset correspondence is a positive deviation direction. The battery with a voltage higher than the average voltage and the maximum deviation difference is selected from the outlier battery set as the target battery. In the charging process, the battery with too high voltage is more likely to reach the full charging state first. If it is not balanced in time, there may be an overcharge risk, so the battery with the largest positive deviation is balanced first.
S6052: If the current state of the battery pack is a discharging state, the voltage deviation direction corresponding to the discharging state in the preset correspondence is a negative deviation direction. The battery with a voltage lower than the average voltage and the maximum deviation difference is selected from the outlier battery set as the target battery. When discharging, the battery with too low voltage may discharge before other batteries, and then produce over-discharge phenomenon, which will affect the battery life. Therefore, priority should be given to the battery with the largest negative deviation to reduce the risk of over-discharge.
S6053: If the current state of the battery pack is in a standing state, the battery with the largest deviation difference is selected from the outlier battery set as the target battery; under the standing state, the voltage state of the battery pack is relatively stable, and the battery with the most serious deviation is selected for equalization, which can quickly improve the voltage consistency of the entire battery pack;
S6054: If there is no battery with the voltage deviation direction corresponding to the current state in the outlier battery set, the battery with the largest deviation difference is selected from the outlier battery set as the target battery.

When the battery pack is in a standing state, there is no obvious influence of charging and discharging current. At this time, the battery with the largest deviation difference is directly selected from the outlier battery set as the target battery. The battery with the most serious deviation is selected for equalization to maximize the overall voltage consistency of the battery pack.

In a concrete embodiment, the preset stop equalization condition includes at least one of the following:

The real-time voltage difference between the average voltage of the target battery and the battery pack is less than the preset deviation threshold;
the maximum pressure difference of the battery pack is less than or equal to the preset maximum pressure difference threshold;
the duration of the charging and discharging operation of the capacitor exceeds the preset equalization time.

In this embodiment, when the real-time voltage difference between the average voltage of the target battery and the battery pack is less than the preset deviation threshold, it means that the voltage of the target battery is close to the average level of the battery pack, and its outlier characteristics basically disappear. It is not necessary to continue to give priority to the battery. It can stop the global priority equalization and enter the local pairwise equalization process.

If the maximum pressure difference of the battery pack is less than or equal to the preset maximum pressure difference threshold, it also shows that the voltage consistency of the entire battery pack has reached the expected goal, and the global priority equalization can be stopped and the local pairwise equalization process can be entered again.

When the duration of the capacitor charging and discharging operation exceeds the preset equalization time, the equalization operation is stopped regardless of the current voltage state. The preset equalization time is set according to the characteristics of the battery pack and the past equalization experience, so as to prevent the unnecessary loss of capacitance and battery caused by long-term equalization and ensure the safety and life of the circuit components.

In a concrete embodiment, the configuration steps of the second preset frequency include:
The distance level d=|i−j| between the i-th equalizer and the target battery j is calculated respectively;
The second preset frequency of the i-th equalizer is configured according to the distance level, and the distance level is inversely proportional to the corresponding second preset frequency.

In this embodiment, the distance level between each equalizer and the target battery is calculated respectively. A higher distance level corresponds to a position farther away from the target battery. According to the distance level, the second preset frequency corresponding to each equalizer is configured, the distance level is inversely proportional to the corresponding second preset frequency. For example, when the distance level is 1, the second preset frequency is 50 kHz; when the distance level is 3, the second preset frequency is 15 kHz, and so on. As the distance level increases, the second preset frequency decreases step by step. The equalizer closer to the target battery is balanced at a higher frequency, which can quickly realize the transfer of energy to the target battery (or from the target battery), improve the energy transfer efficiency, and quickly reach the target battery equalization cut-off condition. The far-distance equalizer works at a lower frequency, which can reduce the loss of energy in the transmission process and reduce the invalid back and forth transmission of energy, thereby improving the stability and efficiency of the entire battery pack equalization process.

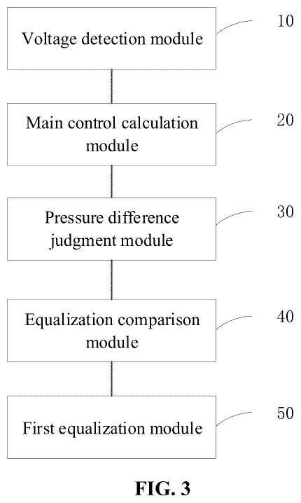

Referring to FIG. 3, the embodiment of the present disclosure discloses a capacitive battery active equalization device, which is applied to the aforementioned capacitive battery active equalization circuit. The capacitive battery active equalization device includes:
A voltage detection module 10, configured to continuously monitor the voltage of each battery in the battery pack through the battery connection pin of each equalizer, and send the voltage to the main control unit;
a main control calculation module 20, configured to calculate the current maximum pressure difference in the battery pack simultaneously by the main control unit, the current maximum pressure difference is the voltage difference between the battery with the highest voltage and the battery with the lowest voltage in the battery pack;
a pressure difference judgment module 30, configured to judge whether the current maximum pressure difference is greater than the preset maximum pressure difference threshold;
an equalization comparison module 40, configured to judge if the current maximum pressure difference is not greater than the preset maximum pressure difference threshold, then the i-th equalizer judges whether the adjacent voltage difference between the i-th battery and the i+1-th battery connected to the i-th equalizer is greater than the first adjacent voltage difference threshold, 1≤i≤n;
the first equalization module 50, configured to connect the capacitor connected to the i-th equalizer to the i-th battery and the i+1-th battery via the switching control module of the i-th equalizer if the adjacent voltage difference of the i-th equalizer is greater than the first adjacent voltage difference threshold, after charging, a battery with a lower voltage is switched for discharging, and the charging and discharging operation of the capacitor is continuously performed at the first preset frequency until the adjacent voltage difference between adjacent batteries is less than or equal to the second adjacent voltage difference threshold.

In a specific embodiment, the capacitive battery active equalization device also includes:
A target battery identification module, configured to identify all the batteries with voltage outliers from the battery pack if the current maximum voltage difference is greater than the preset maximum voltage difference threshold, and a target battery is selected from the battery with voltage outliers to record the serial number j of the target battery;
the first judgment module, configured to judge whether the voltage of the target battery is less than the average voltage of the battery pack;
the second judgment module, configured to judge whether i is less than j for the i-th equalizer if the voltage of the target battery is less than the average voltage of the battery pack;
the second equalization module, configured to judge whether the voltage of the i+1-th battery is less than the voltage of the i-th battery if i<j; if the voltage of the i+1-th battery is less than the voltage of the i-th battery, the capacitor connected to the i-th equalizer is connected to the i-th battery for charging via the switching control module of the i-th equalizer, and then switched to the i+1-th battery for discharging, and the charging and discharging operation of the capacitor is continuously performed at the second preset frequency until the preset stop equalization condition is satisfied; if the voltage of the i+1-th battery is greater than the voltage of the i-th battery, the i-th equalizer does not perform the charging and discharging operation of the capacitor;
the third equalization module, configured to judge whether the voltage of the i+1-th battery is greater than the voltage of the i-th battery if i≥j; if the voltage of the i+1-th battery is greater than the voltage of the i-th battery, the capacitor connected to the i-th equalizer is connected to the i+1-th battery for charging via the switching control module of the i-th equalizer, and then switched to the i-th battery for discharging, and the charging and discharging operation of the capacitor is continuously performed at the second preset frequency until the preset stop equalization condition is satisfied; if the voltage of the i+1-th battery is less than the voltage of the i-th battery, the i-th equalizer does not perform the charging and discharging operation of the capacitor.

In a specific embodiment, the capacitive battery active equalization device also includes:
The third judgment module, configured to judge whether i is less than j for the i-th equalizer if the voltage of the target battery is greater than the average voltage of the battery pack;
the fourth equalization module, configured to judge whether the voltage of the i+1-th battery is less than the voltage of the i-th battery if i≥j, if the voltage of the i+1-th battery is less than the voltage of the i-th battery, the capacitor connected to the i-th equalizer is connected to the i-th battery for charging via the switching control module of the i-th equalizer, and then switched to the i+1-th battery for discharging, and the charging and discharging operation of the capacitor is continuously performed at the second preset frequency until the preset stop equalization condition is satisfied; if the voltage of the i+1-th battery is greater than the voltage of the i-th battery, the i-th equalizer does not perform the charging and discharging operation of the capacitor;
the fifth equalization module, configured to judge whether the voltage of the i+1-th battery is greater than the voltage of the i-th battery if i<j; if the voltage of the i+1-th battery is greater than the voltage of the i-th battery, the capacitor connected to the i-th equalizer is connected to the i+1-th battery for charging via the switching control module of the i-th equalizer, and then switched to the i-th battery for discharging, and the charging and discharging operation of the capacitor is continuously performed at the second preset frequency until the preset stop equalization condition is satisfied. If the voltage of the i+1-th battery is less than the voltage of the i-th battery, the i-th equalizer does not perform the charging and discharging operation of the capacitor.

In a concrete embodiment, the target battery identification module comprises:
The first calculation unit, configured to calculate the average voltage of the battery pack;
the second calculation unit, configured to calculate the deviation difference between the voltage of each battery and the average voltage;
the collection unit, configured to take the battery with the deviation difference exceeding the preset deviation threshold as the battery with voltage outlier, and add all the battery with voltage outlier to the outlier battery set;
the state judgment unit, configured to judge the current state of the battery pack, and the current state is selected from the charging state, the discharging state and the standing state;
the target battery selection unit, configured to select the voltage deviation direction corresponding to the current state of the battery pack from the outlier battery set according to the preset correspondence between the state-voltage deviation direction, and the battery with the largest deviation difference is selected as the target battery.

In a concrete embodiment, the target battery selection unit includes:
The first selection sub-unit, configured to select the battery with the voltage deviation direction corresponding to the charging state in the preset correspondence as the positive deviation direction if the current state of the battery pack is the charging state, the battery with the voltage higher than the average voltage and the maximum deviation difference is selected from the set of outlier batteries as the target battery;
the second selection sub-unit, configured to select the battery with the voltage deviation direction corresponding to the discharging state in the preset correspondence as the negative deviation direction if the current state of the battery pack is in the discharging state, the battery with the voltage lower than the average voltage and the maximum deviation difference is selected from the set of outlier batteries as the target battery;
the third selection sub-unit, configured to select the battery with the largest deviation from the outlier battery set as the target battery if the current state of the battery pack is in a standing state;
the fourth selection sub-unit, configured to select the battery with the largest deviation difference from the outlier battery set as the target battery if there is no battery with the voltage deviation direction corresponding to the current state in the outlier battery set.

In a concrete embodiment, the preset stopping equalization condition includes at least one of the following:
The real-time voltage difference between the average voltage of the target battery and the battery pack is less than the preset deviation threshold;
the maximum pressure difference of the battery pack is less than or equal to the preset maximum pressure difference threshold;
the duration of the charging and discharging operation of the capacitor exceeds the preset equalization time;
In one embodiment, the configuration steps of the second preset frequency include:
   The distance level d=|i−j| between the i-th equalizer and the target battery j is calculated respectively.

The second preset frequency of the i-th equalizer is configured according to the distance level, the distance level is inversely proportional to the corresponding second preset frequency.

The capacitive battery active equalization device of the embodiment of the present disclosure, through the judgment of the current maximum pressure difference and the preset maximum pressure difference threshold, when the overall voltage consistency of the battery pack is good, only local equalization is started, and each equalizer works independently to ensure that the voltage of each part of the battery pack is always maintained within a reasonable range, avoiding unnecessary global equalization coordination and improving the overall equalization efficiency. At the same time, when the overall voltage consistency of the battery pack is good, the main control unit is mainly responsible for the global state monitoring. The specific equalization operation is completed independently by each equalizer, which reduces the operation load of the main control unit and makes the response of the whole equalization system more rapid and stable.

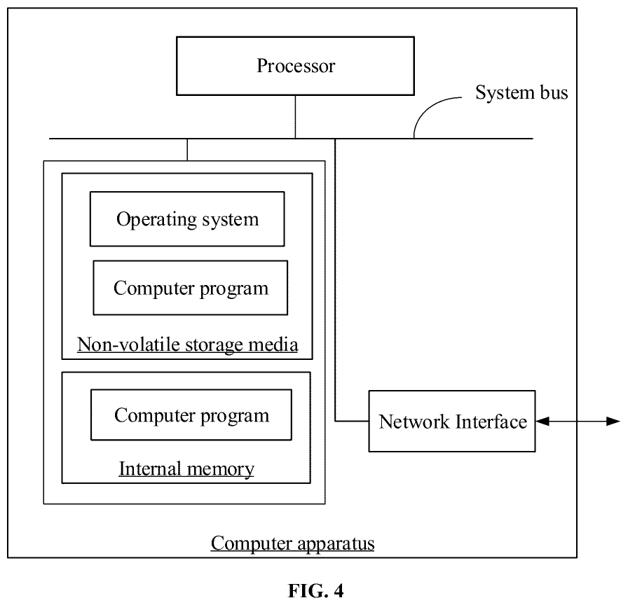

FIG. 4 shows the internal structure diagram of the computer apparatus in an embodiment. The computer apparatus can be a terminal or a server. As shown in FIG. 4, the computer apparatus includes a processor, memory, and network interface connected via a system bus. Among them, the memory includes non-volatile storage media and internal memory, the non-volatile storage medium of the computer apparatus stores the operating system and can also store the computer program. When the computer program is executed by the processor, the processor can realize the capacitive battery active equalization method. The memory can also store a computer program. When the computer program is executed by the processor, the processor can execute the capacitive battery active equalization method. The technicians in this field can understand that the structure shown in FIG. 4 is only a block diagram of some structures related to the present disclosure scheme, and does not constitute a limitation on the computer apparatus applied to the present disclosure scheme, the specific computer apparatus can include more or less components than shown in the figure, or combine some components, or have different component layouts.

In one embodiment, a computer apparatus including a memory and a processor is proposed, the memory stores a computer program, and when the computer program is executed by the processor, the processor is made to perform the following steps:
The voltage of each battery in the battery pack is continuously monitored through the battery connection pins of each equalizer, and the voltage is sent to the main control unit.

The main control unit calculates the current maximum pressure difference in the battery pack simultaneously by the main control unit, the current maximum pressure difference is the voltage difference between the battery with the highest voltage and the battery with the lowest voltage in the battery pack;
whether the current maximum pressure difference is greater than the preset maximum pressure difference threshold is judged;
if the current maximum pressure difference is not greater than the preset maximum pressure difference threshold, then the i-th equalizer judges whether the adjacent voltage difference between the i-th battery and the i+1-th battery connected to it is greater than the first adjacent voltage difference threshold, 1≤i≤n;

If the adjacent voltage difference of the i-th equalizer is greater than the first adjacent voltage difference threshold, the capacitor connected to the i-th equalizer is connected to the i-th battery and the i+1-th battery through the switching control module of the i-th equalizer, after charging the battery with higher voltage, it is switched to the battery with lower voltage for discharging, and the charging and discharging operation of the capacitor is continuously performed at the first preset frequency until the adjacent voltage difference between adjacent batteries is less than or equal to the second adjacent voltage difference threshold.

Through the judgment of the current maximum pressure difference and the preset maximum pressure difference threshold, when the overall voltage consistency of the battery pack is good, only local equalization is started, and each equalizer works independently to ensure that the voltage of each part of the battery pack is always maintained within a reasonable range, which avoids unnecessary global equalization coordination and improves the overall equalization efficiency. Meanwhile, when the overall voltage consistency of the battery pack is good, the main control unit is mainly responsible for the global state monitoring. The specific equalization operation is completed independently by each equalizer, which reduces the operation load of the main control unit and makes the response of the whole equalization system more rapid and stable.

The general technical personnel in this field can understand all or part of the process of implementing the above implementation method, which can be completed by computer program to instruct the relevant hardware, the program can be stored on a non-volatile computer readable storage medium, when the program is executed, it can include the process of the implementation of the above methods. Among them, any reference to memory, storage, database, or other media used in each embodiment provided by the present disclosure may include non-volatile and/or volatile memory. Nonvolatile memory can include read-only memory (ROM), programmable ROM (PROM), electrically programmable ROM (EPROM), electrically erasable programmable ROM (EEPROM) or flash memory. The volatile memory can include random access memory (RAM) or external high-speed buffer memory. As an illustration rather than a limitation, RAM is available in a variety of forms, such as static RAM (SRAM), dynamic RAM (DRAM), synchronous DRAM (SDRAM), dual data rate SDRAM (DDRSDRAM), enhanced SDRAM (ESDRAM), synchronous link DRAM (SLDRAM), memory bus direct RAM (RDRAM), direct memory bus dynamic RAM (DRDRAM), and memory bus dynamic RAM (RDRAM).

The technical features of the above implementations can be arbitrarily combined. In order to make the description simple, all possible combinations of the technical features in the above implementations are not described. However, as long as there is no contradiction in the combination of these technical features, it should be considered as the scope recorded in this specification.

The above embodiments only express several implementation methods of the present disclosure, and their descriptions are more specific and detailed, but they cannot be understood as restrictions on the scope of the present disclosure. It should be pointed out that for the ordinary technical personnel in this field, some deformations and improvements can be made without breaking away from the idea of the present disclosure, which are all within the protection scope of the present disclosure. Therefore, the protection scope of the present disclosure should be subject to the attached claims.

What is claimed is:

1. A capacitive battery active equalization method, wherein the method is applied to a capacitive battery active equalization circuit, wherein the circuit comprises a battery pack, an equalizer set, an energy storage capacitor group, and a main control unit, the equalizer set comprises n equalizers, each equalizer comprises a battery connection pin, a capacitor connection pin, a switching control module and a control signal interaction pin; the adjacent equalizers are connected to each other through the control signal interaction pins; the main control unit is connected with the control signal interactive pin of a first equalizer or a last equalizer in the equalizer set; the battery pack comprises n+1 batteries connected in series; the battery connection pins of the i-th equalizer are connected to an i-th battery and an i+1-th battery respectively; 1≤i≤n; the energy storage capacitor group includes n capacitors, each capacitor is connected to the capacitor connection pin of a corresponding equalizer; wherein the method comprises:
monitoring a voltage of each battery in the battery pack continuously by the battery connection pins of each equalizer, and sending a voltage to the main control unit;
calculating a current maximum voltage difference in the battery pack simultaneously by the main control unit, the current maximum voltage difference is a voltage difference between a battery with a highest voltage and a battery with a lowest voltage in the battery pack;
judging whether the current maximum pressure difference is greater than the preset maximum pressure difference threshold;
if the current maximum pressure difference is greater than the preset maximum pressure difference threshold, identifying all batteries with voltage outliers from the battery pack, and selecting a target battery from the batteries with the voltage outliers, and recording a sequence number j of the target battery;
judging whether a voltage of the target battery is less than an average voltage of the battery pack;
if the voltage of the target battery is less than the average voltage of the battery pack, for the i-th equalizer, judging whether i is less than j;
if i<j, then judging whether a voltage of the i+1-th battery is less than the voltage of the i-th battery, respectively; wherein, if the voltage of the i+1-th battery is less than the voltage of the i-th battery, the capacitor connected to the i-th equalizer is connected to the i-th battery for charging via the switching control module of the i-th equalizer, and then switching to the i+1-th battery for discharging, and performing the charging and discharging operation of the capacitor continuously at a second preset frequency until a preset stop equalization condition is satisfied; if the voltage of the i+1-th battery is greater than the voltage of the i-th battery, the i-th equalizer does not perform the charging and discharging operation of the capacitor; and
if i≥j, then judging whether the voltage of the i+1-th battery is greater than the voltage of the i-th battery, respectively; wherein, if the voltage of the i+1-th battery is greater than the voltage of the i-th battery, the capacitor connected to the i-th equalizer is connected to the i+1-th battery for charging via the switching control module of the i-th equalizer, and then switching to the i-th battery for discharging, and performing the charging and discharging operation of the capacitor continuously at the second preset frequency until the preset stop equalization condition is satisfied; if the voltage of the i+1-th battery is less than the voltage of the i-th battery, the i-th equalizer does not perform the charging and discharging operation of the capacitor.

2. The capacitive battery active equalization method according to claim 1, wherein after judging whether the current maximum pressure difference is greater than the preset maximum pressure difference threshold, the steps also comprise:
if the current maximum pressure difference is not greater than a preset maximum pressure difference threshold, then the i-th equalizer judges whether an adjacent voltage difference between the i-th battery and the i+1-th battery connected to the i-th equalizer is greater than a first adjacent voltage difference threshold, wherein 1≤i≤n; and
if the adjacent voltage difference of the i-th equalizer is greater than the first adjacent voltage difference threshold, connecting the capacitor connected to the i-th equalizer to the i-th battery and the i+1-th battery via the switching control module of the i-th equalizer, after charging the battery with a higher voltage, switching to the battery with a lower voltage for discharging, and performing a charging and discharging operation of the capacitor continuously at a first preset frequency until an adjacent voltage difference between adjacent batteries is less than or equal to a second adjacent voltage difference threshold.

3. The capacitive battery active equalization method according to claim 1, wherein after judging whether the current maximum pressure difference is greater than the preset maximum pressure difference threshold, the steps also comprise:
if the voltage of the target battery is greater than the average voltage of the battery pack, for the i-th equalizer, judging whether i is less than j;
if i≥j, then judging whether the voltage of the i+1-th battery is less than the voltage of the i-th battery, respectively; if the voltage of the i+1-th battery is less than the voltage of the i-th battery, the capacitor connected to the i-th equalizer is connected to and the i-th battery for charging via the switching control module of the i-th equalizer, and then switched to the i+1-th battery for discharging, and performing the charging and discharging operation of the capacitor continuously at the second preset frequency until the preset stop equalization condition is satisfied; if the voltage of the i+1-th battery is less than the voltage of the i-th battery, the i-th equalizer does not perform the charging and discharging operation of the capacitor; and
if i<j, then judging whether the voltage of the i+1-th battery is greater than the voltage of the i-th battery, respectively; if the voltage of the i+1-th battery is greater than the voltage of the i-th battery, the capacitor connected to the i-th equalizer is connected to the i-th battery for charging via the switching control module of the i-th equalizer, and then switched to the i-th battery for discharging, and performing the charging and discharging operation of the capacitor continuously at a second preset frequency until a preset stop equalization condition is satisfied; if the voltage of the i+1-th battery is less than the voltage of the i-th battery, the i-th equalizer does not perform the charging and discharging operation of the capacitor

4. The capacitive battery active equalization method according to claim 1, wherein identifying all batteries with voltage outliers from the battery pack, and selecting a target battery from the batteries with the voltage outliers, the steps comprise:
calculating the average voltage of the battery pack;
calculating a deviation difference between the voltage of each battery and the average voltage, respectively;
wherein the battery whose deviation difference exceeds a preset deviation threshold is used as the battery with voltage outliers, and adding all batteries with voltage outliers to an outlier battery set;
judging a current state of the battery pack, and the current state is selected from a charging state, a discharging state and a standing state;
according to a preset correspondence between a state-voltage deviation direction, selecting a voltage deviation direction corresponding to the current state of the battery pack from the outlier battery set, and selecting the battery with a largest deviation difference as the target battery.

5. The capacitive battery active equalization method according to claim 4, wherein according to the preset correspondence between the state-voltage deviation direction, a voltage deviation direction corresponding to the current state of the battery pack is selected from the outlier battery set, and the battery with a largest deviation difference is selected as the target battery, wherein the steps comprise:
if the current state of the battery pack is a charging state, the voltage deviation direction corresponding to the charging state in the preset correspondence is a positive deviation direction, and the battery with a voltage higher than the average voltage and the maximum deviation difference is selected from the outlier battery set as the target battery;
if the current state of the battery pack is a discharging state, the voltage deviation direction corresponding to the discharging state in the preset correspondence is a negative deviation direction, and the battery with the voltage lower than the average voltage and the maximum deviation difference from the outlier battery set is selected as the target battery;
if the current state of the battery pack is a standing state, the battery with the largest deviation difference from the outlier battery set is selected as the target battery;
if there is no battery with the voltage deviation direction corresponding to the current state in the outlier battery set, the battery with the largest deviation difference from the outlier battery set is selected as the target battery.

6. The capacitive battery active equalization method according to claim 1, wherein the preset stop equalization condition comprises at least one of the following:
a real-time voltage difference between an average voltage of the target battery and the battery pack is less than the preset deviation threshold;
the maximum pressure difference of the battery pack is less than or equal to the preset maximum pressure difference threshold;
a duration of the charging and discharging operation of the capacitor exceeds a preset equalization time.

7. A capacitive battery active equalization device, wherein the device is applied to the capacitive battery active equalization circuit, wherein the circuit comprises a battery pack, an equalizer set, an energy storage capacitor group, and a main control unit, the equalizer set comprises n equalizers, each equalizer comprises a battery connection pin, a capacitor connection pin, a switching control module and a control signal interaction pin; the adjacent equalizers are connected to each other through the control signal interaction pins; the main control unit is connected with the control signal interactive pin of a first equalizer or a last equalizer in the equalizer set; the battery pack comprises n+1 batteries connected in series; the battery connection pins of the i-th equalizer are connected to an i-th battery and an i+1-th battery respectively; 1≤i≤n; the energy storage capacitor group includes n capacitors, each capacitor is connected to the capacitor connection pin of a corresponding equalizer; wherein the capacitive battery active equalization device comprises:
a voltage detection module, configured to continuously monitor the voltage of each battery in the battery pack through the battery connection pin of each equalizer, and send the voltage to the main control unit;
a main control calculation module, configured to calculate the current maximum pressure difference in the battery pack simultaneously by the main control unit, wherein the current maximum pressure difference is the voltage difference between the battery with the highest voltage and the battery with the lowest voltage in the battery pack;
a pressure difference judgment module, configured to judge whether the current maximum pressure difference is greater than the preset maximum pressure difference threshold;
wherein, if the current maximum pressure difference is greater than the preset maximum pressure difference threshold, identifying all batteries with voltage outliers from the battery pack, and selecting a target battery from the batteries with the voltage outliers, and recording a sequence number j of the target battery;
a first judgment module, configured to judge whether the voltage of the target battery is less than the average voltage of the battery pack;
a second judgment module, configured to judge whether i is less than j for the i-th equalizer if the voltage of the target battery is less than the average voltage of the battery pack;
a second equalization module, configured to judge whether the voltage of the i+1-th battery is less than the voltage of the i-th battery if i<j; wherein, if the voltage of the i+1-th battery is less than the voltage of the i-th battery, the capacitor connected to the i-th equalizer is connected to the i-th battery for charging via the switching control module of the i-th equalizer, and then switched to the i+1-th battery for discharging, and the charging and discharging operation of the capacitor is continuously performed at the second preset frequency until the preset stop equalization condition is satisfied; if the voltage of the i+1-th battery is greater than the voltage of the i-th battery, the i-th equalizer does not perform the charging and discharging operation of the capacitor; configuration steps of the second preset frequency comprises: calculating a distance level d=|i−j| between the i-th equalizer and the target battery j, respectively; configuring a second preset frequency of the i-th equalizer according to the distance level, where the second preset frequency is configured to decrease as the distance level increases;
a third equalization module, configured to judge whether the voltage of the i+1-th battery is greater than the voltage of the i-th battery if i≥j; wherein, if the voltage of the i+1-th battery is greater than the voltage of the i-th battery, the capacitor connected to the i-th equalizer is connected to the i+1-th battery for charging via the switching control module of the i-th equalizer, and then switched to the i-th battery for discharging, and the charging and discharging operation of the capacitor is continuously performed at the second preset frequency until the preset stop equalization condition is satisfied; if the voltage of the i+1-th battery is less than the voltage of the i-th battery, the i-th equalizer does not perform the charging and discharging operation of the capacitor.

8. A computer apparatus, comprising a memory and a processor, the memory stores a computer program, and when the computer program is executed by the processor, the processor performs the steps of the capacitive battery active equalization method according to claim 1.
